(19) United States
(12) Patent Application Publication
(10) Pub. No.: US 2008/0059302 A1
(43) Pub. Date: Mar. 6, 2008

(54) LOYALTY PROGRAM SERVICE

(76) Inventors: Edward W. Fordyce III, Hagerstown, IN (US); Karteek Hasmukh Patel, San Francisco, CA (US); Sarah Pankratz Suarez, South San Francisco, CA (US); David Chauncey Shepard, Novato, CA (US)

Correspondence Address: Quarles & Brady LLP, TWO NORTH CENTRAL AVENUE, One Renaissance Square, PHOENIX, AZ, 85004-2391, US

(21) Appl. No.: 11/767,202

(22) Filed: Jun. 22, 2007

Related U.S. Application Data
(60) Provisional application No. 60/824,275, filed on Aug. 31, 2006.
(60) Provisional application No. 60/824,426, filed on Sep. 1, 2006.
(60) Provisional application No. 60/915,079, filed on Apr. 30, 2007.
(60) Provisional application No. 60/895,111, filed on Mar. 15, 2007.

(51) Int. Cl. G06Q 30/00

(52) U.S. Cl. 705/14

(57) ABSTRACT

A loyalty program associated with a payment processing system is constructed, implemented, and refined through collaboration between collaborative constituents in the payment processing system. A first collaborative constituent may transmits a proposal having at least one parameter of the loyalty program to another collaborative constituents. The first collaborative constituent may receive a response to the proposal and transmit a reply based on the response. All remaining collaborative constituents in the negotiation process agree to a negotiated set of parameters. The negotiated set of parameters for the loyalty program is communicated to a loyalty program implementer that can be one of the collaborative constituents. The same process of proposal, response, and reply can be utilized to refine the negotiated set of parameters as long as the remaining collaborative constituents agree that refinement is in order.

### CROSS-REFERENCES TO RELATED APPLICATIONS

This application is a Non-Provisional Application and claims priority to and the benefit of U.S. Provisional Patent Application Ser. No. 60/824,275 (entitled “Loyalty Programs and Services,” filed Aug. 31, 2006), the entire contents of which is hereby incorporated by reference; this application also claims priority to and the benefit of U.S. Provisional Patent Application Ser. No. 60/824,426 (entitled “Method and System for Loyalty Programs and Services,” filed Sep. 1, 2006), the entire contents of which is hereby incorporated by reference; this application also claims priority to and the benefit of U.S. Provisional Patent Application Ser. No. 60/915,079 (entitled “Transaction Data Matching,” filed Apr. 30, 2007), the entire contents of which is hereby incorporated by reference; and this application also claims priority to and the benefit of U.S. Provisional Patent Application Ser. No. 60/895,111 (entitled “Point of Service Discounting,” filed Mar. 15, 2007), the entire contents of which is hereby incorporated by reference.

### FIELD

The present invention generally relates to loyalty programs and more particularly, to methods, systems and apparatus for facilitating the development and implementation of a loyalty program through the use of a platform.

### BACKGROUND

Loyalty programs provide consumers with incentives to shop at certain loyalty program participating facilities or to show loyalty to a particular merchant or service provider, such as a financial institution. In addition to receiving discounts or financial awards, an incentive may include redeemable goods or services, or special recognition of some sort, such as an upgrade. Often, financial institutions, such as an issuing bank or acquiring bank, support the loyalty program. Loyalty programs may be associated with various transaction programs such as a credit card program, a charge card program, a debit card program, a prepaid card program, or a gift card program.

A degree of success of a loyalty program is how well it can target consumers that will participate in the program in order to receive the incentives described and provided as part of the loyalty program.

These loyalty programs are typically constructed, marketed, qualified, fulfilled, or refined with limited interaction between the various participants of the programs, which may include merchants, financial institutions such as acquirers and issuers, transaction handlers such as credit card companies, and consumers such as an account holder. For example, a merchant wishing to participate in a co-branded credit card program may be confined to loyalty program features set by the issuing bank such as a credit limit, a bonus mile to purchase ratio, or a redemption option thereby not being able to finely target the merchant's potential consumers. The level of loyalty program feature confinement is especially prominent among merchants with a smaller portion of the market.

Moreover, loyalty programs may be developed with limited access to detailed transaction data. For example, some loyalty program participants, such as financial institutions, may rely on their own transaction data history to determine the type of incentive to provide. However, this data history may be limited in scope depending on the degree of transaction specificity the issuer collects or is able to maintain. Similarly, merchants wishing to set up a loyalty program may solicit financial institutions for information, gaining limited access to the full scope of the transaction data. Even if a merchant gains access to the transaction data, the transaction data may not be in a form the merchant can effectively utilize.

The lack of uniformity in handing transaction data may hamper accurate communication between participants of the transaction program. For example, acquirers may identify a single merchant differently; one acquirer may identify a merchant by its name and address while another acquirer may identify the same merchant by its name and franchise store number. Similarly, each participant of the loyalty program may be accustomed to processing transaction data in a particular format that may not be the same as the format of another participant of the loyalty program. For example, an airline company may analyze transaction data in units of “bonus miles per dollar” while an issuer may record dollars spent per month.

Therefore, packaged loyalty program services of a financial institution may not properly meet the needs of merchants that could otherwise benefit from loyalty programs. Often, loyalty program participants lack detailed information about transactions and, thus, fail to create an effective and targeted program that is refined to meet the specific needs of those funding the programs. It would be an advance in the art to provide a platform for collaborating to develop, implement and refine transaction programs in a way that lessens the foregoing drawbacks.

### SUMMARY

Phases in a life cycle of a loyalty program are facilitated from creation to implementation to refinement. In one implementation, a proposal is formed containing at least one parameter for the loyalty program in accordance with a predetermined set of business rules for a loyalty program associated with a transaction processing system. The proposal is transmitted to a collaborative constituent. A response is received to the transmitted proposal from the collaborative constituent having a favor or disfavor position of the collaborate constituent to at least one parameter for the loyalty program and, optionally, containing a different parameter for the loyalty program. A reply is formed to the received response. The reply is transmitted to a collaborative constituent, and there is received a negotiated set of parameters for the loyalty program to which all collaborative constituents have communicated favor. As such, the communicated favor for the negotiated set of parameters forms a negotiated agreement to the negotiated set of parameters, and the negotiated agreement is communicated to at least one loyalty program implementer for the remaining collaborative constituents.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a schematic illustrating an exemplary system for collaborating to develop, implement, and refine a loyalty program via a platform configured to be accessible to various collaborative constituents;

FIG. 2 illustrates a flow chart of an exemplary method for collaborating to develop, implement, and refine a loyalty program having at least one parameter;

FIG. 3 is a schematic of an exemplary transaction lifecycle the phases of which can be facilitated within the environment of the system illustrated in FIG. 1;

FIG. 4 is a schematic illustrating an exemplary platform and components of a loyalty program; and

FIG. 5 is a block level diagram illustrating an exemplary transaction processing system that can be part of the system illustrated in FIG. 1.

### DETAILED DESCRIPTION

Implementations enable collaborative constituents to collaborate to construct, implement, refine, or a combination thereof, a loyalty program. For example, entities within a transaction processing system, such as a credit card payment processing system, may become collaborative constituents collaborating during various phases of the loyalty program.

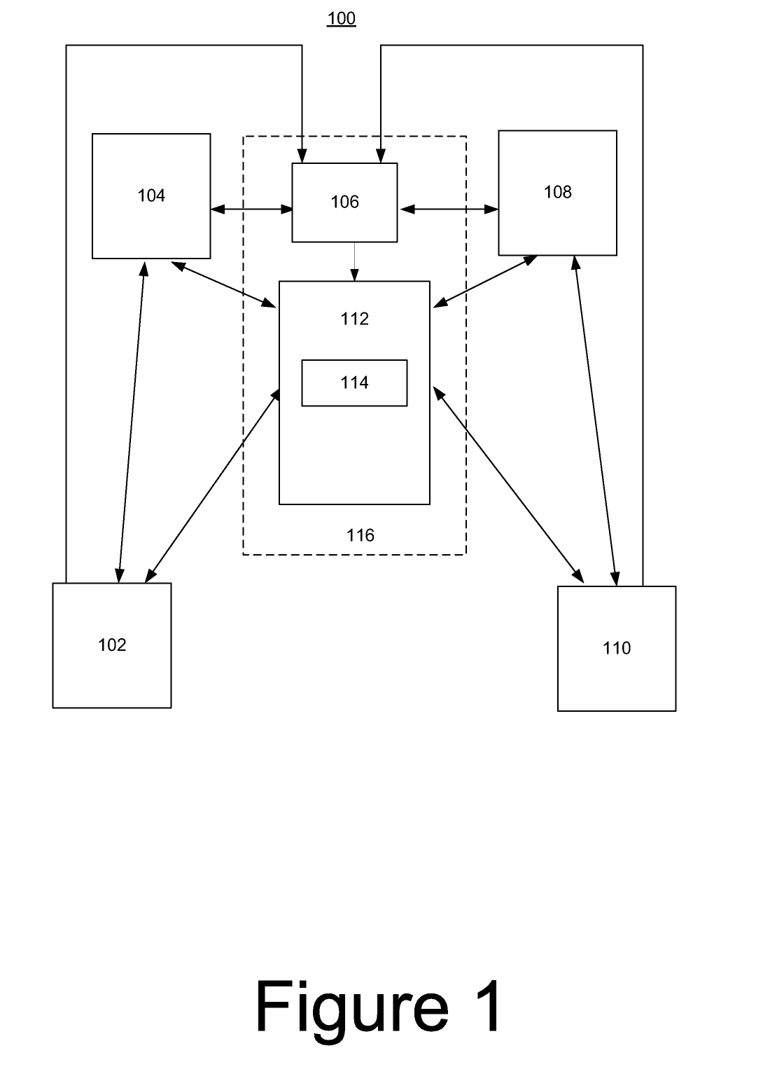

Referring to FIG. 1, an exemplary system is illustrated for collaborative constituents to collaborate on developing, implementing, and refining a loyalty program 114 via a platform 112.

The collaborative constituent may include a consumer 102 such as an account holder in the transaction processing system, an issuer 104, a transaction handler such as a credit card company, an acquirer 108, or a merchant 110. The merchant 110 may be a person or entity that sells goods or services such as, a manufacturer, a distributor, a retailer, a load agent, or a doctor's office. In a business-to-business setting, the consumer 102 may be a second merchant making a purchase from the merchant 110. Third party processors may perform many operational support tasks on behalf of the collaborative constituent, such as creative agencies, loyalty program marketing agencies or consultants, business intelligence companies or consultants, letter shops, Email and SMS or Text message delivery agencies, and registered card loyalty program companies.

A participant of the loyalty program 114 can be, but need not be one of the collaborative constituent. For example, the franchiser McDonald's Corporation may be one of the collaborative constituents having a McDonald's® loyalty program accessible through the platform 114 and one of a McDonald's® loyalty program participant; however, a single McDonald's® store located in Los Angeles, Calif. may not be one of the collaborative constituents but be one of the McDonald's® loyalty program participant wherein purchases made at the single McDonald's Corporation store would qualify for the McDonald's® loyalty program.

The platform 112 can be a forum accessible via a network, the Internet, an extranet, a wireless network, a wire line network, a local area network, a wide area network, a messaging system, a correspondence system, or a telephone system that is a market place for collaborative constituents to interact to construct, implement, and refine the loyalty program 114. The platform 112 may be a part the transaction handler 106 as denoted by broken lines 116 in FIG. 1.

The platform 112 can be scaled to meet the needs of any number of the collaborative constituents. For example, the platform 112 may be configured to accommodate a small or a large number of collaborative constituents, globally, in multiple languages.

Moreover, the platform 112 can be scaled to meet the needs of the participants of the loyalty program 114. For example, the number of participants of the loyalty program 114 for each entity may vary, such as having several franchisees as the participants of the loyalty program 114 for a single franchisor. Similarly, the platform 112 may be configured to allow different numbers of entities to participate in the loyalty program 114. For example, the merchant 110 can be a single merchant that may interact with a single financial institution to create and maintain the loyalty program 114. Conversely, a large number of merchants can create the loyalty program 114 through interaction with a large number of financial institutions. For example, all merchants selling clothing in the southwest can interact with several banks, such as Wells Fargo and Bank of America, to create and maintain the loyalty program 114.

Moreover, the platform 112 may be configured to accommodate modularity in the loyalty program 114. The modularity in the loyalty program 114 includes the loyalty program 114 that has the characteristic of being versatile, allowing for a combination of diverse features. The loyalty program 114 may be created and maintained having features that existed in another pre-existing loyalty program 114 and unique features that did not exist before being put together in an a la carte fashion. For example, the loyalty program 114 may include the entirety of a pre-existing loyalty program 114 as part of its own features such as having a point to cash back ratio mimicking a pre-existing loyalty program 114.

The collaborative constituents may set up a profile within the platform 112. The platform 112 may have a secure Internet setting configured to allow the collaborative constituent access to the platform 112. The profile may include information about the collaborative constituent. For example, the consumer 102 may set up a profile including information about the consumer 102 such as the consumer 102 name, the consumer 102 address, the consumer 102 account number for an account within the transaction processing system, the consumer 102 inputted data such as preference for particular promotion or preference 102 for a channel for receiving promotions, the consumer 102 business categories that the consumer 102 would like to receive promotions for, or the consumer 102 shopping habits. The issuer 104 may set up a profile including information about the issuer 104 such as an issuer unique identifier within the transaction processing system (a global unique identifier (GUID) that distinguishes the issuer 104 within the transaction processing system), issuer address, issuer standard loyalty program business rules typically proposed by the issuer 104 for a plurality of loyalty programs 114, issuer loyalty program fulfillment options (e.g., credit to statement or cash back), issuer standard loyalty program parameters, and information on third parties that act as proxies to the issuer 104. The acquirer 108 may set up a profile including information about the acquirer 108 such as an acquirer unique identifier (a GUID that distinguishes the acquirer 108 within the transaction processing system), acquirer address, a settlement request, merchant identification, or accumulated merchant daily sale report. The transaction handler 106 may set up a profile including information about the transaction handler 106 such as transaction message field formatting requirements, authorization standards for a transaction amount, credit card spending limits by credit card type, or demographic analysis. The merchant 110 may set up a profile including information about the merchant 110 such as a merchant unique identifier (a GUID that distinguishes the merchant 110 within the transaction processing system), franchise codes, or merchant standard loyalty business rules.

An exemplary questionnaire for creating a profile for the merchant 110 is as follows:
Merchant Name:
Originator's Contact:
Date of Request:
Description of project:
What are the business objectives?
Describe the marketing environment: names of competitors, current attitudes of target audience(s), etc.:
Provide logo, if applicable
What are the business objectives?
What are the main benefits of this project to each audience, in order of priority?
What is the key message we want to communicate to each audience?
What do we want each audience to do or believe as a result of this project?
What Transaction Processor materials would provide background information? (Please attach.)
Additional information or direction:
What information would help Marketing Communications and Agency determine the copy tone or style for the overall project? Do certain components need a different tone?
What type of copy input will be provided (copy points, brochures, URLs)?
What information would help Marketing Communications and Agency determine the design tone or style for the overall project?
Are there any print production issues or requirements for this project?
Offer Period:
Offer Redemption Process (e.g. coupon, statement credit). (If using bar codes, specify type, positioning, size and other requirements here).
Will offer be available online?
If offer will be available online, provide online code requirements. Attach additional spreadsheet if needed.
Will offer be available via catalog?
If offer will be available via catalog, provide code and requirements.
Attach additional spreadsheet if needed.
Creative branding guidelines and considerations. If branding guidelines are available, please provide here as well.
Delivery method
   Letter with coupon
   Buckslip
   Insert (if doing an insert, please provide size and specs)
   e-mail
   mobile
Cashier instructions (to be placed on coupon):
Merchant messaging (if applicable):
Phone number and/or URL for offer:
Who will review each round of creative?
How many days should we schedule for originator's group to review rounds if different than normal VIN review times?
List the primary and secondary target audience(s).
Potential audience/segments:
Will there be a customer suppression list? If so, please provide description and date this will be available (see Customer Suppression File Format)
Will a Merchant Store Location List be provided for geo-coding purposes (if applicable)?
Please describe any targeting requirements:
Location/Geographies:
Type of program output:
   Qualified Transactions Only
   Calculated Awards
   Discounts
   Bonus Points
   Statement Credits
   Discount File
Transaction Purchase Start Date:
Transaction Purchase End Date:
Cardholder Selection Criteria
If transactions will be qualified based on cardholder information, please complete this section.
Transactions will be identified at the following level:
   Issuer BID
   Issuer Card Range
   Issuer BIN
   Participating/Eligible Cardholder List
Approximate number of participating/eligible cardholders:
Cardholder files will be updated with the following frequency:
   Daily
   Weekly
   Monthly
   Other—Please specify below:
Transaction files will be delivered with the following frequency:
   Daily
   Weekly
   Monthly
   At the end of the promotion period
   Other—Please specify below:
Selection Criteria
If transactions will be qualified based on specific information, please provide selection criteria.
Transactions will be qualified based on (check one):
   Acquirer BIN(s)
   Merchant Category Codes
   List of Specific Participating Merchants
   Merchant IDs
   Other (specify);
Additional Transaction Selection Criteria
Please briefly describe any additional targeting qualification criteria that must be applied.
Option Limits
Applies only if calculating awards.
Program Limits:
   Dollar amount
   Points
   Number of Awards
Please specify below:
Option Limits
Applies only if calculating awards.
Cardholder Limits:
   Dollar amount
   Points
   Number of Awards
Bonus Processing:
Please list the bonus point ratio here.
Statement Credits
How is the program funded?
   Merchant funded
   Issuer funded
   Transaction Processor funded
   Third party loyalty provider
Funding BIN
Please specify funding BIN for statement credit processing

Another example of a questionnaire for creating a profile includes:
1. Please select whether your promotion(s) should be provided to:
   a. Consumers
   b. Small Businesses
   c. Both
2. Please select the objective for your promotion: (tips/templates on ads/promotions that work for the merchant's stated industry may be suggested—the tips/templates will change based upon objectives and the issuer 104 can edit the parameters and copy etc. . . . )
   a. Reward existing customers
   b. Increase spend from existing customers
   c. Obtain sales from new customers
   d. Would you like assistance in creating your promotion?
3. Provide some targeting parameters:
   a. Geographical:
      (i) Region
      (ii) City
      (iii) Draw your own borders
      (iv) Within X miles of your address
   b. Check the business types that may buy from you
   c. Include people from previous promotions?
   d. Would you like to target customers who spend (include spend bands)
   e. Would you like to target customers who are similar in characteristics to your existing customers?
4. How would you like your promotion to appear?
   a. Statement credit
   b. Coupon
   c. POS
   d. Email
   e. Mobile
   f. Statement insert for bank
   g. Visa or bank promotion site
5. When would you like your promotion to first appear?
6. What is the promotion period for your promotion?
7. Pricing
   a. What is your budget? (the merchant 110 enters budget and system provides approximate number of cardholders addressed based upon parameters selected)
   b. Enter # of cardholders desired (system calculates pricing based upon parameters selected)

The collaborative constituents can access the platform 112, via the Internet for example, to negotiate parameters of the loyalty program 114 such that a negotiated set of parameters for the loyalty program 114 forms a negotiated agreement to the parameters of the loyalty program 114. Thereafter, the collaborative constituents can implement and refine the parameters of the loyalty program 114.

Each of the collaborative constituent, such as the merchant 110, may submit a proposal, via the platform 112, for the loyalty program 114 containing a parameter that governs the creation and implementation of the loyalty program 114. A parameter may include, for example, the duration of a promotion within the loyalty program 114, the good or service promoted, the value of the promotion, or a loyalty program business rule such as an algorithm to determine whether a purchase qualifies for the promotion. To illustrate, the merchant 110 may propose a loyalty program business rule having the form of: “if parameter one occurs then offer parameter two.” Standard promotions that the merchant 110 may propose include: discounts (e.g., “ten (10) percent off a purchase of socks if you use a Nordstrom® credit card.”), rewards, coupons, and spent-and-get promotions. A coupon promotion may be structured such that if the consumer 102 uses an account associated with the transaction processing system to make a purchase at the merchant 110 store that exceeds $100 U.S.D. in value, then 10% will be taken off the purchase value at the merchant 110 point of service (POS) device. Similarly, the promotion may be a spend-and-get promotion such as if the consumer 102 conducts four purchases made with the account associated with the transaction processing system at the merchant 110 store the consumer 102 fifth purchase at the merchant 110 store will result in $10.00 U.S.D. being credited to the consumer 102 account associated with the transaction processing system. The parameter transmitted in the proposal may be predetermined such that the merchant 110 pick the parameter a la cart within a menu provided at the platform 114, or they may be customized.

The merchant 110 may also select the type of consumer 102 it wishes to target the promotion to. For example, the merchant 110 may want to target the consumer 102 based on geographical location or the consumer 102 transaction history. The merchant's 108 proposal may indicate that the promotion should be targeted to consumers 102 living within 10 miles from the location of one of the merchant 110 franchisee stores. Alternatively, or in combination, the merchant's 108 proposal may indicate that the promotion should be targeted to consumers 102 that have purchased a particular good or service in the past—such as consumers 102 that have purchased baseball cards at competitor stores within the past two months. For example, if the merchant 110 wishes to target consumers that have purchased DVDs in the past, the transaction handler 106 may mine a database containing a plurality of the consumer 102 transaction histories, looking for trends of purchases dealing with DVDs. Once a set of eligible consumers is identified, the transaction handler 106 may query the merchant 110 to refine the set of eligible consumers.

The other collaborative constituents may negotiate with the collaborative constituent that submitted the proposal until the parameters of the loyalty program 114 are agreed upon among the collaborative constituents. For example, the collaborative constituent that submitted the proposal may receive a response thereto indicating that the parameter for the loyalty program 114 is not agreed upon. Consequently, the collaborative constituent that submitted the proposal may transmit a reply to the response including an alternative parameter for the loyalty program 114.

Thereafter, a loyalty program implementer, such as one of the collaborative constituents that agreed on a set of parameters for the loyalty program 114 may, implement the loyalty program 114. For example, as one of the loyalty program implementers, the issuer 104 may disseminate a Nordstrom® credit card account number associated with the loyalty program 114 to the consumer 102. Dissemination modes may include direct mail, email, cellular phone transmissions, and/or messages sent to the consumer 102 via the merchant's 108 POS device (e.g., a message printed on the receipt).

When the consumer 102 uses Nordstrom® credit card account number at the merchant 110 POS terminal to purchase some a good or service such as socks, a transaction message is sent from the merchant 110 POS to the acquirer 108. The transaction message may include fields populated with transaction data for the purchase such as the date, the time, a merchant unique identifier, a promotion code, a Stock Keeping Unit (SKU), a Universal Product Code (UPC), manufacturing codes, geographical distribution codes, or sale, license, or hire value such as an item price. The acquirer 108 may send at least portions of the transaction data for the purchase to the transaction handler 106 that implements the loyalty program business rules (e.g., “ten (10) percent off a purchase of socks if you use a Nordstrom® credit card.”) to the transaction data for the purchase to determine whether the consumer 102 qualifies for the loyalty program 114 and what benefits the consumer 102 should receive if the consumer 102 does qualify. The benefit to the consumer 102 making a sock purchase with the Nordstrom® credit card account number may be a statement credit on the consumer 102 Nordstrom® credit card account equal to ten (10%) percent of the purchase price of the socks. The transaction handler 106, as one of the loyalty program implementers, may forward the result of the determination, the value of the benefit, or combinations thereof to the issuer 104. The platform 112 may provide several tools to facilitate the negotiation process of proposal, response, and reply.

At least a portion of the transaction data for a plurality of purchases, analysis on the transaction data for a plurality of purchases, or combinations thereof may be accessible to the collaborative constituents via the platform 112. For example, the transaction handler 106 may store in a database the transaction data for a plurality of consumers 102 conducting transactions with each respective consumer 102 account within the transaction processing system. The transaction handler may allow collaborative constituents access to a portion of the transaction data for a plurality of consumers 102 stored in the database or a copy of a portion of the transaction data for a plurality of consumers 102 stored elsewhere via the platform 112.

The transaction handler may analyze the transaction data for the plurality of consumers 102 and allow access to the collaborative constituents to the analysis via the platform. Any conventional or predetermined algorithm for data analysis may be used to determine trends within the data of purchases on the account. For example, data mining analysis such as Market Basket Analysis, a pattern recognition analysis, optimization analysis, statistical analysis, a data mining analysis, algorithm demographic analysis, classification analysis, or segmentation analysis can be used. To illustrate, the consumer 102 who has purchased lawn care items in April for the last four years might be identified as being highly likely to purchase lawn care items this April. In another example, general consumer trends may be analyzed to determine highly correlative events, such as “consumers who purchased shoes also buy socks within 90 days of a shoe purchase.” In another example, the consumer 102 purchase behavior trends may be analyzed to reveal consumers 102 which spend a relatively large sum in restaurants, and/or tend to spend significantly larger amounts in restaurants than average restaurant patrons.

The collaborative constituents may repeat the process of proposal, response, and optionally reply to refine the parameters of the loyalty program 114 based in part on the transaction data for a plurality of purchases, analysis on the transaction data for a plurality of purchases, or combinations thereof, for example.

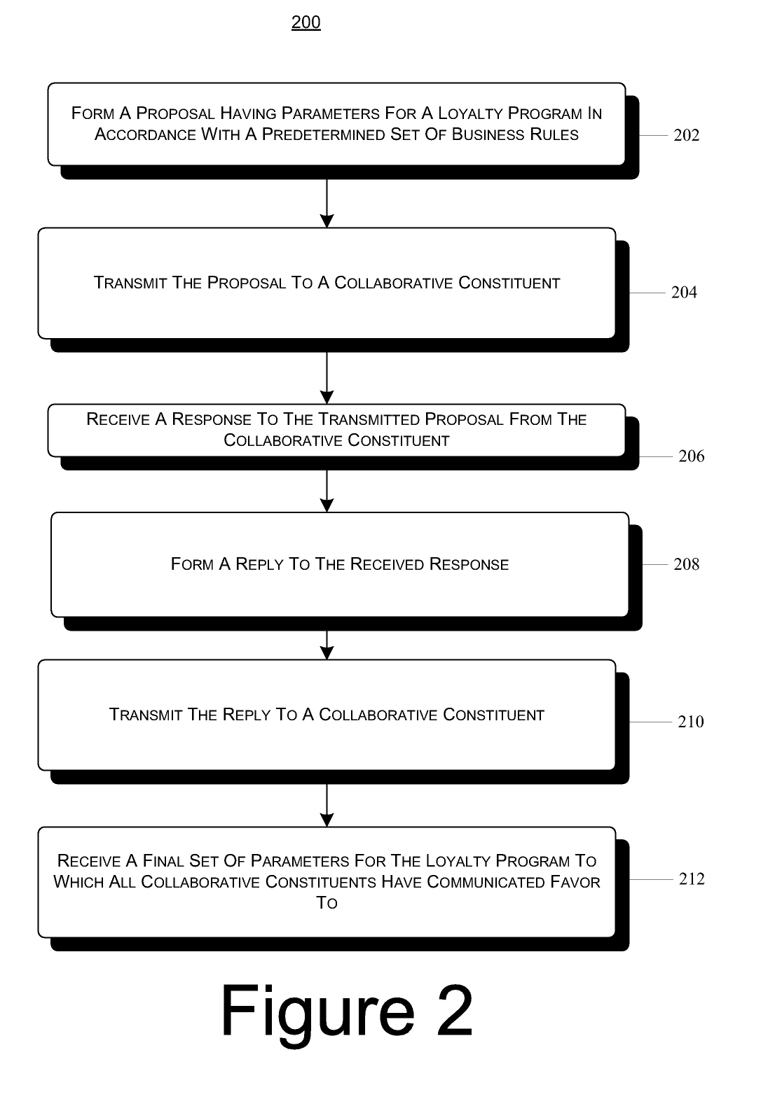

Although a single loyalty program 114 is illustrated in FIG. 2, the loyalty program 114 may be any number of loyalty programs that may be created or maintained within the platform 112. Moreover, any single of the collaborative constituents may be involved in any number of the loyalty programs 114 accessible via the platform 112.

Referring to FIG. 2, another implementation for a method 200 for collaborating to develop the loyalty program 114 begins at step 202.

At step 202, a proposal having parameter(s) for the loyalty program 114 is formed. The parameters may include incentives that may be offered to the consumer 102, limits for the incentives such as a duration for the availability of the incentive, or the location where the incentive may be earned. Parameters for the loyalty program 114 may be based on the merchant's current inventory, the merchant's projected future inventory, or the merchant's past inventory of goods and/or services. The parameters may also include an algorithm (e.g., loyalty program business rule) to determine whether a purchase qualifies for the promotion or incentive such as a spent-and-get promotion or a coupon promotion. For example, a coupon promotion may be structured such that if the consumer 102 uses an account associated with the transaction processing system to make a purchase at the merchant's 110 store that exceeds $100 U.S.D. in value, then 10% will be taken off the purchase value at the merchant's 110 POS device. Other loyalty program business rules may include ratios between the dollar spent and the promotion such as: a dollar spent to a redeemable dollar ratio; a dollar spent to a redeemable discount ratio; a dollar spent to a rebate ratio; a dollar spent to a statement credit ratio; a dollar spent to a good ratio; and a dollar spent to service ratio.

The proposal may be formed in accordance with the predetermined set of business rules. The predetermined set of business rules may include rules on the procedure to form the proposal and/or the business rules may include rules on the content of the proposal for the loyalty program 114. The predetermined set of business rules for the procedure of forming and transmitting the proposal may include: the format of the proposal such as text based message formatting, the prerequisites for submitting a proposal such as identifying the entity making the proposal, or contractual obligations for transmitting a proposal such as an agreement to negotiate in good faith. The predetermined set of business rules for the content of the proposal may include rules delineating the types of parameters that can be proposed. For example, the predetermined business rule may require that the loyalty program 114 rule involve the use of the transaction processing system. To illustrate, a predetermined business rule may require that proposals for the loyalty program 114 must reward the use of a particular brand of credit card. Similarly, a predetermined business rule may require that the transaction messages associated with a transaction be in a particular format, such as magnetic stripe format with fields that can be populated. For example, the business rule may include a rule for populating the transaction message with the merchant unique identifier.

At step 204, the proposal is transmitted to a collaborative constituent. A transmission of the proposal can be formed that is addressed to at least one other collaborative constituent. A third party may transmit the proposal to the destined collaborative constituent. For example, the proposal can be addressed to the collaborative constituent via an email address. Alternatively, the address can be to a category of collaborative constituents such as “all issuers within the transaction processing system.” The third party may then transmit the proposal to the collaborative constituent in accordance with a workflow identifying the order of deliver of the proposal addressed to the collaborative constituent(s). The workflow may identify a sequence of collaborative constituents that should receive the proposal such as in a series or parallel sequence. The merchant 110 may form a proposal for a spend-and-get loyalty program (e.g., buy two shoes get the third one free). To illustrate, the merchant 110 may address the proposal to two collaborative constituent issuers 104: Wells Fargo and Bank of America, via the transaction handler 106. The transaction handler 106 may receive the proposal and send the proposal to both Wells Fargo and Bank of America at the same time. The transaction handler 106 may analyze the proposal to make sure it comports with the predetermined set of business rules prior to transmitting the proposal to either Wells Fargo or Bank of America.

At step 206, a response from the collaborative constituent to the transmitted proposal is received. The response may be transmitted to the entity that formed the proposal and/or to another collaborative constituent via a workflow identifying a predefined order of delivery thereof. In the example above, Wells Fargo may wish to respond favorably to the merchant's 110 spend-and-get proposal. Consequently, Wells Fargo may respond by indicating that it will help create and implement the spend-and-get loyalty program for the consumers 102 that are account holder with Wells Fargo. Wells Fargo may also present a counter proposal in its reply stating that if spend-and-get loyalty program availability to the consumer 102 is limited to the months of March through May, Wells Fargo can credit the value of the third shoe on the statement of the consumer 102 that is an account holder with Wells Fargo such that the consumer 102 can charge the purchase of the third shoe at the merchant's 110 store but Wells Fargo will apply a credit for the value of the third shoe to the consumer's 102 Wells Fargo® account. Consequently, the response can be used to further negotiate the parameters of the proposed loyalty program 114, for example, by containing a favor or disfavor of the at least one parameter for the loyalty program 114.

The response may contain further detail on how the loyalty program 114 can be implemented. For example, the issuer 104 may respond to the merchant's 110 proposal for the loyalty program 114 by indicating how the issuer 104 may market the loyalty program 114 to the issuer's 104 account holders such as: identifying the consumer 102; creating a marketing collateral for the loyalty program 114; delivering the marketing message to the at least one consumer 102; registering a potential consumer for the loyalty program 114; or a combination of the foregoing.

At step 208, a reply to the response can be formed. The reply may also be in accordance to the predetermined set of business rules for the loyalty program 114. For example, the reply may state that the merchant 110 expresses favor to Wells Fargo's response to the spend-and-get loyalty program proposal further indicating that transaction messages from the merchant 110 for each consumer 102 purchase will include a code for the spend-and-get loyalty program so that Wells Fargo can distinguish the consumer 102 that has made a purchase toward the spend-and-get loyalty program at the merchant's 110 store.

At step 210, the reply is transmitted to at least one collaborative constituent. The reply may be transmitted to any collaborative constituent such as the collaborative constituent that sent the response. For example, the merchant 110 may transmit the reply of favor to Wells Fargo's response by sending the reply in a Short Message Service (SMS) to the transaction handler 106 that forward the SMS to Wells Fargo. Alternatively, or in combination, the merchant 110 may address the reply to Bank of America inquiring if Bank of America is willing to make a better deal than that sent by Wells Fargo. Bank of America may transmit a Bank of America response including a set of parameters that the merchant 110 may find more favorable.

The workflow for the order of delivery of the proposal, response, or reply may be serial (e.g., sequential such that each addressed collaborative constituent receives the transmission consecutively), parallel (e.g., such that each addressed collaborative constituent receives the transmission concurrently) or a combination thereof. Moreover, the workflow for the proposal, response, or reply may be the same as each other or different from each other. The collaborative constituent can optionally specify the workflow for the order of delivery of each of the proposal, response, or reply.

The steps of 202 through 210 may be repeated until an agreement is reached. For examples, proposals, responses, and replies may contain offers, counteroffers, and acceptances from the collaborative constituents developing the parameters for the loyalty program 114. The repetition of the steps 202 through 210 may take several iterations and collaborative constituents may participate or stop participating at any step of 202 through 210.

The business case for parameters can be made during the negotiation process (e.g., steps 202 through 210). The collaborative constituents may evaluate the business case for a parameter and argue its effectiveness to the other collaborative constituents involved in the negation. For example, the business case may entail: determining a cost and a benefit for the parameter; determining a cost and a benefit for not having the parameter; determining a business need that the parameter may address; performing a gap analysis; determining a reason for the parameter; or determining a reasons for one of favoring and disfavoring the parameter.

The collaborative constituents may use analytical tools to determine the effectiveness of at least one parameter of the loyalty program 114 being negotiated. The analytical tools can include: a data mining tool; a reporting tool; a metrics tool; a demographics tool; an analytic tool; a targeting tool; a statistic tool; a segmentation analysis tool; a tool for determining at least a cost and a benefit for the parameter; a tool for determining at least a cost and a benefit for not having the parameter; a tool for determining the business need that the parameter will address; a tool for gap analysis; a tool for determining a reason for the parameter; a tool for determining the reasons for at least one of favoring and disfavoring the parameter; or a combination of the foregoing.

The transaction handler 106 may provide the other collaborative constituents, via the platform 112, data mining tools and access to a plurality of the consumer's 102 transaction data during the negotiation process. For example, the merchant 110, such as a hardware store, may want to know the transaction history of a plurality of the consumers 102 living within 10 miles of the merchant 110 hardware store—specifically, the transaction history of purchases of florescent lights. The transaction handler 106 may have access to a database containing the transaction history of a plurality consumers 102 within the transaction processing system. The transaction handler 106 may allow the merchant 110 access to an analytical tool, such as a data mining tool, to filter out the florescent light transaction history of consumers 102 within ten miles of the merchant's 110 hardware store. The outcome of the analytical tool may indicate that only twenty florescent light purchases have been made within the last month within the ten mile radius of the merchant's 110 hardware store. The merchant 110 may determine that a loyalty program centered on florescent lights may not be feasible for the merchant 110. Consequently, the merchant 110 may transmit a reply indicating that the merchant 110 will no longer participate in the negotiation of the loyalty program 114 that is centered around florescent lights.

At step 212, a negotiated set of parameters to which all remaining collaborative constituents have communicated favor to the negotiated set of parameters is received, the negotiated set of parameters being the parameters for the loyalty program 114. The negotiated set of parameters can be the minimum parameters that collaborative constituents need to agree on in order to implement the loyalty program 114, such as at least one loyalty program business rule and the promotion. The negotiated set of parameters need not have all of the details to implement the loyalty program 114. For example, the address for the location for all merchants 110 that will participate in the loyalty program 114 need not be settled. The negotiated set of the parameters for the loyalty program 114 may be received from at least one implementer of the loyalty program 114.

The remaining collaborative constituents need not communicate favor to each and every parameter in the negotiated set of parameters; rather, the remaining collaborative constituents can communicate favor to the negotiated set of parameters. The remaining collaborative constitutes are those that have not expressed a desire to exit the negotiation process or those that have not contributed to the negotiation process for a period of time (e.g., days or months), such that their non-contribution indicates a desire to exit the negotiation process.

The communicated favor for the negotiated set of parameters forms a negotiated agreement to the negotiated set of parameters that can be communicated to at least one loyalty program implementer for the remaining collaborative constituents. The implementation of the loyalty program 114 may include: marketing, loyalty program qualification, fulfillment, and refinement of the loyalty program 114.

The loyalty program implementer may be any collaborative constituent, such as one of the remaining collaborative constituents, that facilitates the implementation of the loyalty program 114. The loyalty program implementer may transmit the negotiated set of the parameters for the loyalty program to the collaborative constituents. For example, one of the loyalty program implementers may be the transaction handler 106 that facilitates the implementation of the loyalty program 114 negotiated between the merchant 110 and the issuer 104. Once the both the merchant 110 and the issuer 104 agree on the parameters of the loyalty program 114, the transaction handler 106 may send the negotiated set of the parameters for the loyalty program to both the merchant 110 and the issuer 104.

To illustrate, the merchant 110 may be coffee shop wishing to create and implement a coffee shop loyalty program for its patrons. The coffee shop owner may form a coffee promotion proposal using an interactive interface on a network in communication with the transaction processing system, the promotion proposal including a parameter indicating that the coffee shop loyalty program should have a spend-and-get promotion wherein patrons can purchase five cups of coffee and receive the sixth one free.

The coffee shop owner may use an interface device connected to the system for collaborating to develop, implement, and refine a loyalty program, such as a cellular telephone with an Internet connection, to log on to the transaction handler's 106 website and input the proposed spend-and-get promotion parameters. Other forms of interface include: a personal computer, a personal digital assistant, a hand-held computing device, a mobile computing device having telephony functionality, a cellular telephone, a mobile consumer device, and a combination of the foregoing. The coffee shop owner may transmit the coffee promotion proposal to the issuer 104, a Wells Fargo® bank, via the transaction handler 106.

The Wells Fargo® bank can transmit a response indicating favor to the coffee promotion proposal further indicating that the coffee shop loyalty program should be marketed to patrons living within ten minutes from the coffee shop. The coffee shop owner may agree, submitting a reply to the response expressing favor to the ten-minute limitation not having discussed if the ten minutes is calculated based on using surface streets or the subway. The coffee shop owner and Wells Fargo® bank may agree that the spend-and-get promotion and the ten minute limitation are the parameters for the coffee shop loyalty program thereby forming the negotiated agreement for the coffee shop loyalty program even without knowing if the ten minute limitation is calculated based on the using surface streets or the subway.

The negotiated agreement for the coffee shop loyalty program, including the negotiated set of parameters, can then be communicated to at least one loyalty program implementer, such as the transaction handler 106, that can facilitate implementing the coffee shop loyalty program. For example, the transaction handler 106, may assist the Wells Fargo® bank marketing, qualifying, determining fulfillment, and refining of the coffee shop loyalty program.

After the negotiated agreement is communicated to at least one loyalty program implementer, the loyalty program 114 may be refined. Refinement may include renegotiating a parameter within the negotiated set of parameters or negotiating a new parameter. The refinement may occur before or after the loyalty program 114 has been implemented as long as the remaining collaborative constituents agree that the negotiated set of parameters can be further negotiated. The refinement may include similar steps as the negotiation process (e.g., steps 202 through 212): a refinement proposal in accordance with a predetermined set of business rules for the loyalty program 114 associated with the transaction processing system can be formed and transmitted to an addressed collaborative constituent; a refinement response from the addressed collaborative constituent can be received, wherein the response is to the transmitted refinement proposal; a refinement reply to the received refinement response in accordance with the predetermined set of business rules for the loyalty program 114 associated with the transaction processing system may be formed and transmitted; a second negotiated set of parameters to which all remaining collaborative constituents have communicated favor to the second negotiated set of parameters can be received, the second negotiated set of parameters being the parameters for the loyalty program 114 that has been refined; and a second negotiated agreement to the second negotiated set can be communicated to at least one loyalty program implementer.

A computer program product can be configured to enable a computer to facilitate loyalty program 114. Software instructions for enabling the computer to perform predetermined operations facilitating construction, marketing, loyalty program qualification, fulfillment, and refinement of loyalty program 114 can be accessible from a computer readable medium bearing the software instructions for the methods beginning at step 202. For example, transaction handler 106 may maintain the computer such as by controlling access to the platform 112, hosting the computer, or controlling the flow of transmissions.

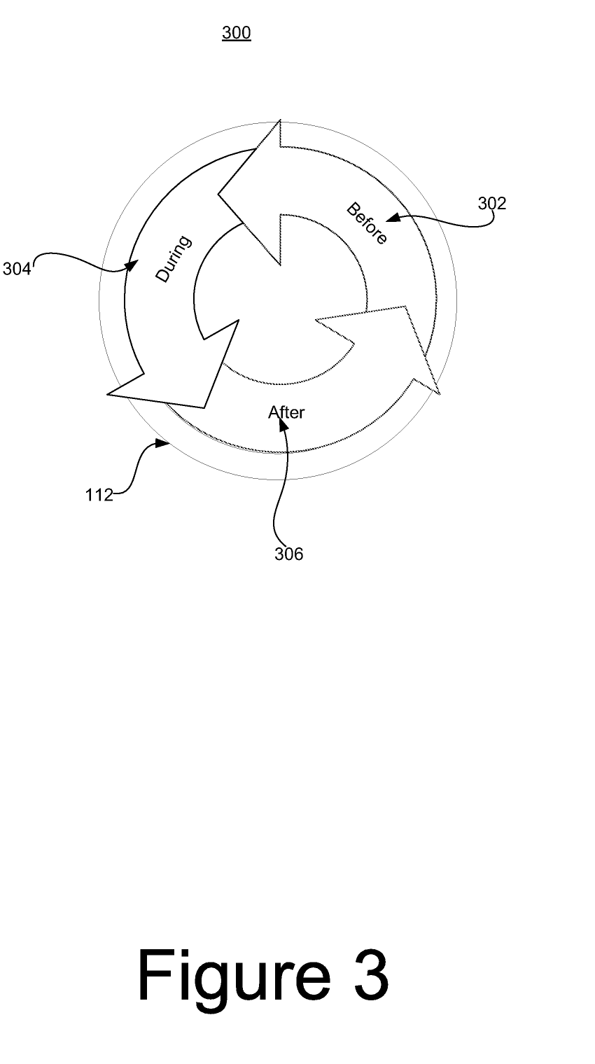

FIG. 3 is a schematic of a transaction lifecycle 300 for the loyalty program 114 including the phases of a Before Phase 302, a During Phase 304, and an After Phase 306. In one embodiment, the platform 112 supports the loyalty program 114 throughout the transaction lifecycle 300.

At the Before Phase 302, the loyalty program 114 may be created using the platform 112. For example, potential consumer information may be analyzed at the Before Phase 302 including obtaining one or more transaction files of corresponding potential consumers, transforming the files into readable form, and segmenting and identifying the potential consumer of the loyalty program 114. Moreover, negotiations can occur with collaborative constituents, such as the issuer 104 or the merchant 110 to construct loyalty program business rules in order to determine what transactions may qualify for the loyalty program 114.

At the During Phase 304, the platform 112 can facilitate information exchange. For example, information in a transaction message associated with a transaction may be relayed to a participant of the loyalty program 114 such as the transaction handler 106 that in turn relays the information in the transaction message to the other participant of the loyalty program 114 via the platform 112. Moreover, the information in the transaction message may be analyzed such as by qualifying and authenticating non-financial data (e.g., authenticating the merchant's 110 merchant unique identifier).

At the After Phase 306, the platform 112 can facilitate the refinement of the loyalty program 114. For example, the loyalty program 114 can be refined to better meet the needs and intended goals of the participants by evaluating the transaction data of a plurality of consumers 102 that have participated in the loyalty program 114.

The actions described for each of the Before Phase 302, the During Phase 304, or the After Phase 306, are not limited to a particular phase alone. For example, construction of the loyalty program 114, construction of loyalty program business rules, analysis of information, and negotiation between collaborative constituents, can occur at the Before Phase 302, the During Phase 304, and/or the After Phase 306. For example, at the After Phase 306, a new parameter of the loyalty program 114 can be created. Similarly, actions such as facilitating the exchange of transaction data and analysis of the transaction message can occur at the Before Phase 302, the During Phase 304, and/or the After Phase 306. For example, at the After Phase 306, the information in the transaction message may be analyzed. Moreover, actions such as further qualifying the transaction message, refining the loyalty program 114 and fulfillment calculation and realization can occur at the Before Phase 302, the During Phase 304, and/or the After Phase 306,. For example, at the Before Phase 302, the loyalty program 114 may be further refined and the qualifying fulfillment for the loyalty program 114 may occur at the During Phase 304 (e.g., discount at the POS).

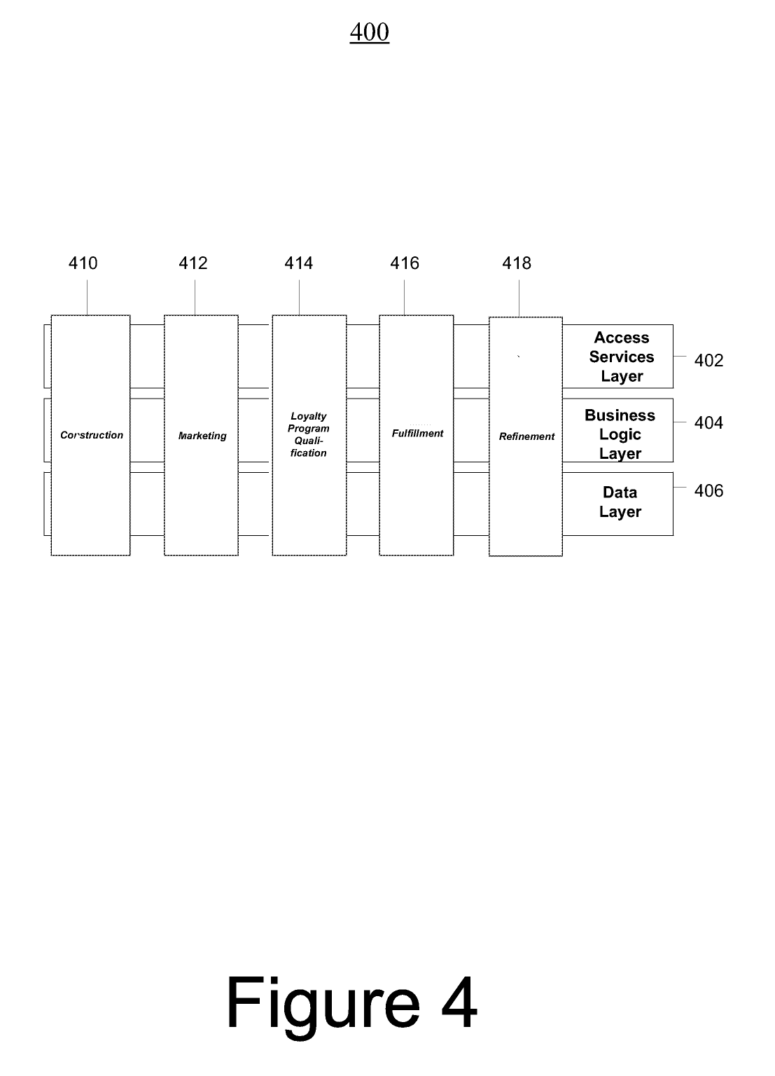

FIG. 4 is a schematic illustrating various layers of the platform 112 that the collaborative constituent may have access to and the components of the loyalty program 114 that the platform 112 can facilitate.

Several layers can support the platform 112 including an access services layer 402, a business logic layer 402, and the data layer 406. The access services layer 402 of the platform 112 represents the common data interface between collaborative constituents. Via the access services layer 402, collaborative constituents can communicate with one another in a market place type environment. For example, each collaborative constituent may transmit proposals, responses, and/or replies under a predetermined set of business rules.

The business logic layer 404 is the infrastructure within the platform 112 that supports collaboration between collaborative constituents. For example, the business logic layer 404 may include a server, a database, and a program that can determine whether the consumer's 102 transaction for the purchase of a hammer qualifies for the merchant's 110 loyalty program involving hand carpentry tools.

The data layer 406 represents transaction data that may be available to the collaborative constituent at the platform 112. The transaction data come from various sources including: information from the consumer 102, information from the issuer 104, information from the acquirer 108, information from the transaction handler 106, or information from the merchant 110. The information from the consumer 102 may include: consumer 102 identification such as name or address, consumer account identification such as account number, consumer inputted data such as preference for particular incentives, or consumer shopping trends. The information from the issuer 104 may include: the issuer unique identifier, issuer address, issuer business rules, issuer fulfillment options, cumulated consumer 102 information for a period of time, issuer transaction program features, and information on third parties that act as proxies to the issuer 104. The information from the acquirer includes: the acquirer unique identifier, acquirer address, the merchant unique identifier, or accumulated merchant daily sale report. The information from the transaction handler 106 may include: transaction message field formatting requirements, authorization for a transaction amount, credit card spending limit, credit history, or demographic analysis. Information from the merchant 110 may include: the merchant unique identifier, franchise codes, merchant business rules codes, or other information from the merchant about the transaction.

The transaction data may also includes different types of information including: a transaction message; product or service information such product or service type, SKU number, chain of distribution, manufacturing codes, and geographical distribution codes; sale, license, or hire value information such as an item price; transaction program business rule; loyalty incentive information such as points, rewards, or cash back; an offer, negotiation, or a posting transaction cost information such as cost of processing a token transaction.

The collaborative constituents can access the platform 112 to facilitate various components of the loyalty program 114 including: construction 410, marketing 412, loyalty program qualification 414, fulfillment 416, and refinement 418 components of the loyalty program 114.

The collaborative constituents may access the platform 112 for the construction 410 component of the loyalty program 114. Through the access layer 402, two or more of the collaborative constituents can interact to construct loyalty program 114. The construction 410 of the loyalty program 114 can include: constructing the business case that supports a parameter of the loyalty program 114, posting proposals, negotiating proposals, or identifying potential participants. For example, the collaborative constituent may choose from predetermined parameters in constructing the loyalty program 114, negotiating them in isolation or combinations. The collaborative constituent, such as the merchant 110, may transmit proposal containing a parameter that the merchant 110 wishes another of the collaborative constituents to accept (e.g., express favor to), identify the consumer 102 such as a consumer group desired to become a recipient of the proposal, or elect to receive information from the data layer 406 regarding the consumer.

Through the use of the data layer 406, collaborative constituents can construct the loyalty program 114 targeting the consumer 102. For example, the loyalty program 114 can be a loyalty program that utilizes high level product information (e.g., a SKU) as a trigger for the loyalty program business rule. The trigger can be product category specific “music players,” or product line specific such as iPod® nano, or a manufacturer such as Apple Computer, Inc. Consequently, the collaborative constituent involved in different levels of the chain of distribution such as a manufacturer, a distributor, a retailer, or the merchant 110, can better target the loyalty program 114 promotion via the platform 112.

Moreover, the collaborative constituent, such as the issuer 104, can manage its participation in the loyalty program 114 such as during the construction 410 component of the loyalty program 114 and through the access services layer 302. The managing participation in the loyalty program 114 can include: choosing marketing initiatives; registering the issuer's 214 rewards programs, ensuring that the issuer 104 qualifies for certain interchange levels, choosing specific promotions for the consumer 102 to receive or participate in; selecting a method by which proposal messages can be delivered; finding the merchant 110 partners for proposals the issuer 104 would like to run; posting information about proposals the issuer 104 would like to run for the consumer 102 such as what type of cardholder qualifies for the loyalty program 114 or how many cardholders can qualify; obtaining the consumer's 102 transaction data; or choosing proposal parameters.

The merchant 110 can respond, creating proposals that meet the issuer's 214 parameters. For example, Target may want a promotion for its loyalty program 114. Target may utilize the platform 112 to select from a menu of services to support its efforts, including segmenting consumer groups, uploading and approving creative treatments, choosing message delivery channels, processing bonuses, and choosing fulfillment options.

The collaborative constituents may access the platform 112 for the marketing 412 component of the loyalty program 114. For example, the transaction handler 106 can assist a collaborative constituent in the creative development of a marketing strategy, such as creating the marketing collateral, registering a participant of the loyalty program 114 such as the consumer 102, or delivering a marketing messages to the consumer 102 via a number of channels such as email direct mail, email, text messaging, media advertising, pop up advertising, telemarketing, or point of sale communication. The registering of the participant of the loyalty program 114 can include registering collaborative constituents for the loyalty program 114 or registering entities that are not one of the collaborative constituents.

The collaborative constituent may access the platform 112 for the loyalty program qualification 414 component of the loyalty program 114. The loyalty program business rules may be applied to the transaction data associated with the consumer's 102 purchase to determine the loyalty program qualification 414. The transaction data may include data that populate a field within the transaction message associated with the transaction such as the merchant unique identifier, the consumer's 102 account number within the transaction processing system, and information about the product or service purchased, for example.

When a transaction occurs, a unique code that is a GUID for the participant of the loyalty program 114 can populate a field within the transaction message for the transaction. The unique code for the participant of the loyalty program 114 can promote uniformity in the exchange of information amongst the participant of the loyalty program 114 and facilitate the determination of whether the participant of the loyalty program 114 qualifies for the loyalty program 114.

For example, “HD hardware store” has a HD hardware store loyalty program in connection with the issuer 104 developed using the platform 112. HD hardware store may have two franchisee merchants “HD hardware store X” and “HD hardware store Y” each having different acquirers: Acquirer X and Acquirer Y. Acquirer X may keep an internal log on franchisee merchant HD hardware store X with an identifier “9999.” Acquirer Y may keep a separate internal log on HD hardware store Y with an identifier “WQ83.” The issuer 104 involved in the HD hardware store loyalty program may not be able to recognize that hardware store X and hardware store Y have the same franchisor via the internal identifiers of acquirer X “9999” or acquirer Y “WQ83” respectively; consequently, the issuer 104 may have difficulty determining if a purchase at each store would qualify for the HD hardware store loyalty program. On the other hand, if HD hardware store's franchisee's are each assigned merchant unique identifiers, which may not be reliant on acquirer X's internal identifier or acquirer Y's internal identifier, the issuer 104 may be able to better distinguish HD hardware store X or HD hardware store Y as participants of the HD hardware store loyalty program.

Other transaction data that may also be taken into consideration when determining whether a transaction qualifies for the loyalty program 114 include: product Stock Keeping Unit (SKU) numbers, a timestamp for the transaction, a code identifying the consumer 102 as a valued customer, or a code identifying a purchase qualifying for a loyalty program incentive. The collaborative constituent, such as the transaction handler 106, can transform the high level product or service information within the transaction message into a form usable to the collaborative constituent. For example, the SKU number can be subsequently transformed into banking industry file formats, validated, matched to corresponding financial records and delivered to the participant of the loyalty program 114 via a number of different channels.

The collaborative constituent may access the platform 112 for the fulfillment 416 component of the loyalty program 114. For example, once a transaction, or set of transactions qualify for fulfillment of the loyalty program 114, the transaction handler 106 can facilitate fulfillment of that award by taking fulfillment actions including: calculate a bonus based on loyalty program business rules such as awarding bonus points or miles; facilitating providing a statement credit, cash back value, or discount value to the participant of the loyalty program (e.g., consumer 102); forwarding the part of the transaction data regarding the fulfillment to another of the collaborative constituent or to a support group such as a third party having a contractual obligation with the collaborative constituent. The fulfillment actions can occur in real time, as part of the clearing and settlement process, or sometime thereafter, for example.

The collaborative constituents may access the platform 112 for the refinement 418 component of the loyalty program 114. The collaborative constituent, can access tools available at the platform 112 such as reporting, metrics and analytical tools, enabling the collaborative constituent to get statically generated analysis, dynamically generated analysis, or review forward looking promotional calendars to refine the collaborative constituent's marketing strategies. For example, the merchant 110 may access the platform 112 to evaluate the loyalty program's 114 performance. The merchant 110 may create reports via statistical software accessible at the platform 112 and determine the degree that the consumer 102 or any group of targeted consumers 102 has participated in the loyalty program 114 based on features including: demographics, SKU numbers, store locations, seasonal variances, or consumer habits of buying related commodities such as shoes and socks. The merchant 110 may decide to refine the merchant's 110 range of the targeted consumer 102 or promotions in the loyalty program 114 by continuing the negotiation process, such as steps 201 through 210 of FIG. 2.

Although illustrated in a progressive manner, the transaction components of the following can follow any order or be concurrent: the construction 410, the marketing 412, the loyalty program qualification 414, the fulfillment 416, and the refinement 418. For example, the refinement 418 of loyalty program 114 may occur during the marketing 412 component such as by narrowing a group of targeted consumers 102, the fulfillment 416 may occur during the transaction component program qualification 314 component such as when the consumer 102 receives a discount during a purchase, and the marketing 412 can occur during the fulfillment 416 component such as providing the consumer 102 with a coupon for the next purchase. Other combinations are readily conceivable to a person of ordinary skill in the art.

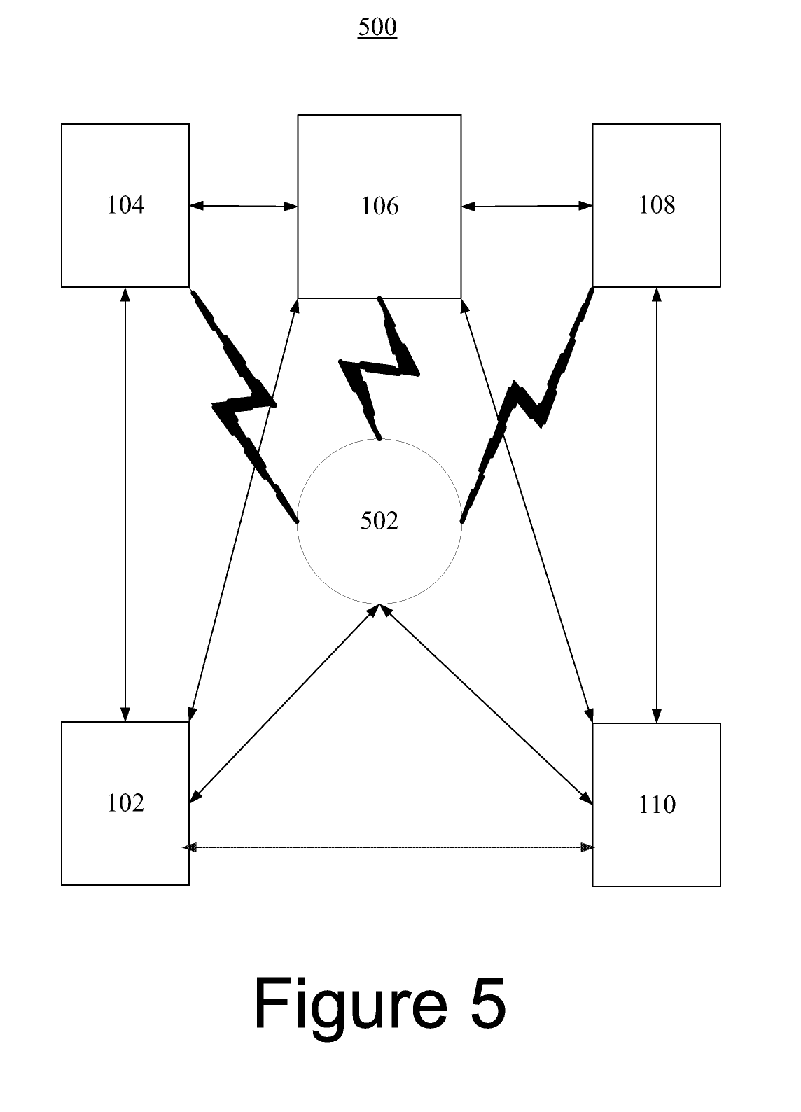

As background information for the foregoing description, as will be readily understood by persons of ordinary skill in the art, a transaction such as a payment transaction, can include participation from different entities that are a component of a transaction processing system. An exemplary such transaction processing system is depicted in FIG. 5 as a payment processing system 500. System 500 includes the issuer 104, the transaction handler 106, such as a credit card company, the acquirer 108, the merchant 110, or the consumer 102. The acquirer 108 and the issuer 104 can communicate through the transaction handler 106. Merchant 110 may utilize at least one POS terminal that can communicate with the acquirer 108, the transaction handler 106, or the issuer 104. Thus, the POS terminal is in operative communication with the payment processing system 500.

Typically, a transaction begins with the consumer 102 presenting a portable consumer device 502 to the merchant 110 to initiate an exchange for a good or service. The portable consumer device 502 may include a payment card, a gift card, a smartcard, a smart media, a payroll card, a health care card, a wrist band, a machine readable medium containing account information, a keychain device such as the SPEEDPASS commercially available from ExxonMobil Corporation or a supermarket discount card, a cellular phone, personal digital assistant, a pager, a security card, an access card, a wireless terminal, or a transponder. The portable consumer device 502 may include a volatile or non-volatile memory to store information such as the account number or an account holder's name.

The merchant 110 may use the POS terminal to obtain account information, such as an account number, from the portable consumer device. The portable consumer device 502 may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 104 of the portable consumer device. Alternatively, or in combination, the portable consumer device 502 may communicate with the issuer 104, the transaction handler 106, or the acquirer 108.

The issuer 104 may authorize the transaction using the transaction handler 106. The transaction handler 106 may also clear the transaction. Authorization includes the issuer 104, or the transaction handler 106 on behalf of the issuer 104, authorizing the transaction in connection with the issuer's 104 instructions such as through the use of business rules. The business rules could include instructions or guidelines from the transaction handler 106, the consumer 102, merchant 110, the acquirer 108, the issuer 104, a financial institution, or combinations thereof. The transaction handler 106 may maintain a log or history of authorized transactions. Once approved, merchant 110 will record the authorization, allowing the consumer 102 to receive the good or service.

Merchant 110 may, at discrete periods, such as the end of the day, submit a list of authorized transactions to the acquirer 108 or other components of the payment processing system 300. The transaction handler 106 may compare the submitted authorized transaction list with its own log of authorized transactions. If a match is found, the transaction handler 106 may route authorization transaction amount requests from the corresponding acquirer 108 to the corresponding issuer 104 involved in each transaction. Once the acquirer 108 receives the payment of the authorized transaction amount from the issuer 104, it can forward the payment to merchant 110 less any transaction costs, such as fees. If the transaction involves a debit or pre-paid card, the acquirer 108 may choose not to wait for the initial payment prior to paying the merchant 110.

There may be intermittent steps in the foregoing process, some of which may occur simultaneously. For example, the acquirer 108 can initiate the clearing and settling process, which can result in payment to the acquirer 108 for the amount of the transaction. The acquirer 108 may request from the transaction handler 106 that the transaction be cleared and settled. Clearing includes the exchange of financial information between the issuer 104 and the acquirer 108 and settlement includes the exchange of funds. The transaction handler 106 can provide services in connection with settlement of the transaction. The settlement of a transaction includes depositing an amount of the transaction settlement from a settlement house, such as a settlement bank, which the transaction handler 106 typically chooses, into a clearinghouse, such as a clearing bank, that the acquirer 108 typically chooses. The issuer 104 deposits the same from a clearinghouse, such as a clearing bank, which the issuer 104 typically chooses into the settlement house. Thus, a typical transaction involves various entities to request, authorize, and fulfill processing the transaction.

The invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. The steps recited in any of the method or process claims may be executed in any order and are not limited to the order presented in the claims.

Various terms may be used herein, which are to be understood according to the following descriptions 1 through 8:

1. Acceptance point device includes a device capable of communicating with a payment device, where the acceptance point device can include a Point of Device (POS) device, a smartcard, a payment card such as a credit or debit card with a magnetic strip and without a microprocessor, a keychain device such as the SPEEDPASS™ commercially available from Exxon Mobil Corporation, a cellular phone, personal digital assistant (PDA), a pager, a security card, an access card, a smart media, a transponder, personal computer (PC), tablet PC, handheld specialized reader, set-top box, electronic cash register (ECR), automated teller machine (ATM), virtual cash register (VCR), kiosk, security system, or access system;

2. Account holder or consumer includes any person or entity with an account and/or a payment device associated with an account, where the account is within a payment system;

3. Issuer includes any entity that issues one or more accounts and/or payment devices;

4. Merchant includes any entity that supports an acceptance point device;

5. Participant includes any consumer, person, entity, charitable organization, machine, hardware, software, merchant or business who accesses and uses the system of the invention, such as any consumer (such as primary member and supplementary member of an aggregate consumer account), retailer, manufacturer, and third-party provider, and any subset, group or combination thereof;

6. Redemption includes obtaining a reward using any portion of points, coupons, cash, foreign currency, gift, negotiable instruments, or securities;

7. Reward includes any discount, credit, good, service, package, event, experience (such as wine tasting, dining, travel), or any other item; and

8. Payment device includes a card, smartcard, ordinary credit or debit cards (with a magnetic strip and without a microprocessor), a keychain device (such as the SPEEDPASS™ commercially available from Exxon-Mobil Corporation), cellular phone, personal digital assistant (PDA), pager, payment card, security card, access card, smart media, or transponder, where each payment device can include a loyalty module with a computer chip with dedicated hardware, software, embedded software, or any combination thereof that is used to perform actions associated with a loyalty program.

It should be understood that the present invention can be implemented in the form of control logic, in a modular or integrated manner, using software, hardware or a combination of both. The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods to implement the present invention.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A method of collaborating to develop a loyalty program for a transaction processing system among collaborative constituents that are selected from a group consisting of an issuer, an acquirer, a merchant, a transaction handler, and combinations thereof, the method comprising:
receiving a proposal containing at least one parameter for the loyalty program, wherein each of the parameters is compliant with a predetermined set of business rules;
forming a first transmission containing a response to the proposal, the first transmission being addressed to at least one of the collaborative constituents in accordance with a first workflow identifying a predefined order of delivery thereof; and
receiving a negotiated set of the parameters for the loyalty program to which each remaining said collaborative constituent has agreed.

2. The method as defined in claim 1, wherein the negotiated set of the parameters for the loyalty program were received from at least one implementer of the loyalty program.

3. The method as defined in claim 1, wherein the reply to the response contains at least one said parameter for the loyalty program.

4. The method as defined in claim 1, wherein the reply to the response contains a position of favor and disfavor of the at least one of the parameter for the loyalty program.

5. The method as defined in claim 1, where the collaborative constituents include one or more consumers each receiving an account associated with the transaction processing system.

6. The method as defined in claim 1, wherein the at least one parameter for the loyalty program is based on inventory of at least one of a good and a service of the merchants.

7. The method as defined in claim 6, wherein the inventory of at least one of a good and a service of the merchants is selected from the group consisting of current inventory, projected future inventory, and past inventory.

8. A computer-readable medium comprising computer readable instructions which, when executed by a processor, performs the method of claim 1.

9. A method of collaborating to develop a loyalty program for a transaction processing system among collaborative constituents selected from a group consisting of an issuer, an acquirer, a merchant, a transaction handler, and combinations thereof, the method comprising:
forming a proposal containing at least one parameter for the loyalty program, wherein each of the parameters is compliant with a predetermined set of business rules for the loyalty program;
forming a first transmission of the proposal, the first transmission being addressed to at least one collaborative constituent in accordance with a first workflow identifying a predefined order thereof;
receiving a response from the addressed at least one collaborative constituent, wherein the response is to the transmitted proposal;
forming a reply to the received response;
forming a second transmission of the reply, the second transmission being addressed to at least one collaborative constituent in accordance with a second workflow identifying a predefined order of delivery thereof; and
receiving a negotiated set of the parameters for the loyalty program to which each remaining said collaborative constituent has agreed.

10. The method as defined in claim 9, wherein the negotiated set of said parameters for the loyalty program were received from at least one loyalty program implementer.

11. The method as defined in claim 9, wherein each said proposal, each said response, and each said reply to the response contains at least one said parameter for the loyalty program.

12. The method as defined in claim 9, wherein each of the proposal, the response, and the reply contains, for each said parameter in the loyalty program, a position of at least one of the collaborative constituents, wherein the position is selected from the group consisting of favor and disfavor.

13. The method as defined in claim 9, wherein the collaborative constituents include one or more consumers each receiving, from one of the issuers, an account associated with the transaction processing system.

14. The method as defined in claim 9, wherein the at least one parameter for the loyalty program is based on inventory of at least one of a good or a service of the merchants.

15. The method as defined in claim 9, wherein the inventory of at least one of a good or a service of the merchant is selected from the group consisting of current inventory, projected future inventory, and past inventory.

16. The method as defined in claim 9, wherein the forming of the proposal, the forming of the first transmission, the receiving of the response, the forming of the reply, and the forming of the second transmission are performed one or more times until all of the remaining said collaborative constituents have communicated favor to the negotiated set of the parameters.

17. The method as defined in claim 9, further comprising interfacing with a network in communication with the payment processing system for the received response, the received negotiated set, and the sending of the first and the second transmissions.

18. The method as defined in claim 9, wherein at least one of the forming of the proposal and the forming of the reply includes creating a business case for the parameter.

19. The method as defined in claim 18, wherein creating the business case includes at least one of:
determining at least a cost and a benefit for the parameter;
determining at least a cost and a benefit for not having the parameter;
determining a business need that the parameter may address;
performing a gap analysis;
determining a reason for the parameter; and
determining a reasons for at least one of favoring and disfavoring the parameter.

20. The method as defined in claim 9, wherein at least one of the forming the proposal and the forming the reply includes picking a la carte from a menu of predetermined parameters.

21. The method as defined in claim 9, further comprising evaluating an effectiveness of at least one parameter of the loyalty program based on the output of an analytical tool.

22. The method as defined in claim 21, wherein an input to the analytical tool includes at least one consumer's transaction history, the transaction history being a history of the at least one consumer's transactions within the transaction processing system.

23. The method as defined in claim 9, wherein at least one parameter for the loyalty program is negotiated through the exchange of the proposal, the response, and the reply between at least two collaborative constituents.

24. The method as defined in claim 9, wherein the first workflow and the second workflow are the same.

25. The method as defined in claim 9, further comprising marketing the loyalty program to at least one consumer.

26. The method as defined in claim 25, wherein marketing the loyalty program is selected from the group consisting of:
identifying the at least one consumer;
creating a marketing collateral for the loyalty program;
delivering the marketing message to the at least one consumer of the loyalty program;
registering a potential consumer of the loyalty program; and
a combination of the foregoing.

27. The method as defined in claim 9, after the receiving a negotiated set of the parameters for the loyalty program, the method further comprising:
agreeing to refine at least one parameter of the negotiated set of the parameters; and
repeating the forming the proposal, the forming the first transmission of the proposal, the receiving the response, the forming the reply, the forming the second transmission of the reply, and the receiving the negotiated set of said parameters for the loyalty program.

28. A computer-readable medium comprising computer readable instructions which, when executed by a processor, performs the method of claim 9.

29. An engine for collaboratively developing a loyalty program, the engine comprising a computer accessible by at least one collaborative constituent to a network and to an electronic storage containing code which, when executed by the computer:
forms a proposal containing at least one parameter for the loyalty program, wherein each of the parameters is compliant with a predetermined set of business rules for the loyalty program;
forms a first transmission of the proposal, the first transmission being addressed to at least one collaborative constituent in accordance with a first workflow identifying a predefined order thereof;
receives a response from the addressed at least one collaborative constituent, wherein the response is to the transmitted proposal;
forms a reply to the received response;
forms a second transmission of the reply, the second transmission being addressed to at least one collaborative constituent in accordance with a second workflow identifying a predefined order of delivery thereof; and
receives a negotiated set of the parameters for the loyalty program to which each remaining said collaborative constituent has agreed.

30. The engine as defined in claim 29, wherein a transaction handler controls the execution of at least part of the code.

31. The engine as defined in claim 29, wherein at least one of the proposal, the response, the reply, and the negotiated set are addressed by the computer for transmission via the network.

32. The engine as defined in claim 29, wherein the first transmission is addressed to an issuer and a transaction handler.

33. The engine as defined in claim 29, wherein a loyalty program implementer is one of the collaborative constituents.

34. The engine as defined in claim 29, wherein the remaining said collaborative constituents includes at least one of:
a collaborative constituent that has submitted at least one of the proposal, the response, and the reply within a predetermined period of time; and
a collaborative constituent that has not indicated that the collaborative constituent no longer is one of the collaborative constituents.

35. The engine as defined in claim 29, wherein an effectiveness of at least one parameter for the loyalty program is evaluated using a relational data base containing at least one consumer's transaction history and at least one of:
a data mining tool;
a reporting tool;
a metrics tool;
a demographics tool;
an analytic tool;
a targeting tool;
a statistic tool;
a segmentation analysis tool;
a tool for determining at least a cost and a benefit for the parameter;
a tool for determining at least a cost and a benefit for not having the parameter;
a tool for determining the business need that the parameter will address;
a tool for gap analysis;
a tool for determining a reason for the parameter;
a tool for determining the reasons for at least one of favoring and disfavoring the parameter; and
a combination of the foregoing.

36. The engine as defined in claim 29, wherein the at least one parameter for the loyalty program associated with payment processing system includes a predetermined parameter selected from a menu of predetermined parameters.

37. The engine as defined in claim 29, wherein the at least one parameter for the loyalty program is based on at least one of a merchant's current inventory, the merchant's projected inventory, and the merchant's past inventory, wherein the inventory includes at least one of a good and a service.

38. The engine for collaboratively developing the loyalty program as defined in claim 29, wherein the predetermined set of business rules includes formatting rules for transmission of a transaction message containing information about a transaction between a merchant and a consumer.

39. The engine as defined in claim 38, wherein the predetermined set of business rules includes a rule for populating the transaction message with a unique merchant identifier.

40. The engine as defined in claim 29, wherein at least one of the first workflow and the second workflow are addressed to at least one collaborative constituent and include a simultaneous order of delivery to the addressed said at least one collaborative constituent.

41. The engine as defined in claim 29, wherein the first workflow or the second workflow, or both the first workflow and the second workflow, include a first delivery to the transaction handler and a subsequent delivery to the addressed said at least one collaborative constituent.

42. The engine as defined in claim 29, wherein the first and second transmissions are addressed to the same said at least one collaborative constituent.

43. The engine as defined in claim 29, wherein at least one of the first transmission and the second transmission are addressed to said at least one collaborative constituent that is in a category of said collaborative constituents.

44. The engine as defined in claim 29, wherein the parameter includes a loyalty program rule to determine a redeemable promotion.

45. The engine as defined in claim 44, wherein the loyalty program rule to determine the redeemable promotion is selected from the group consisting of:
a dollar spent to a redeemable dollar ratio;
a dollar spent to a redeemable discount ratio;
a dollar spent to a rebate ratio;
a dollar spent to a statement credit ratio;
a dollar spent to a good ratio;
a dollar spent to service ratio; and
a combination of the foregoing.

46. A system for a loyalty program comprising:
means for forming a proposal containing at least one parameter for the loyalty program, wherein the parameter is compliant with a predetermined set of business rules for the loyalty program;
means for forming a first transmission of the proposal, the first transmission being addressed to at least one party in accordance with a first workflow identifying a predefined order thereof;
means for receiving a response from the party, wherein the response is to the transmitted proposal;
means for forming a reply to the received response;
means for forming a second transmission, the second transmission being addressed to at least one other party in accordance with a second workflow identifying a predefined order of delivery thereof; and
means for receiving a negotiated set of said parameters for the loyalty program.

47. The system as defined in claim 46, wherein the means for forming a proposal comprises an interface for receiving input in an interactive session to specify at least one of:
the first predefined order of delivery;
the second predefined order of delivery;
the parameter for the loyalty program associated with payment processing;
favor of at least one of the parameters for the loyalty program; and
disfavor of at least one of the parameters for the loyalty program.

48. The system as defined in claim 47, wherein the consumer interface is presented on a computing device selected from the group consisting of:
a personal computer;
a personal digital assistant;
a hand-held computing device;
a mobile computing device having telephony functionality;
a cellular telephone;
a mobile consumer device; and
a combination of the foregoing.

49. The system as defined in claim 46, wherein the means for forming the first transmission and the second transmission includes using a network.

50. The system as defined in claim 49, wherein the network is selected from the group consisting of: an intranet, an extranet, a wireless network, a wire line network, a local area network, a wide area network, and a messaging network.

51. The system as defined in claim 46, further comprising means for analysis of consumer transaction history, the analysis being used to determine the parameter for the loyalty program associated with payment processing.

52. The system as defined in claim 46, wherein the loyalty program is for a payment processing system developed by collaborative constituents including at least one transaction handler and others selected from the group consisting of an issuer, an acquirer, a merchant, and combinations thereof.
